(19) United States
(12) Patent Application Publication
(10) Pub. No.: US 2024/0349749 A1
(43) Pub. Date: Oct. 24, 2024

(54) Device and Method for Processing a Product Mass

(71) Applicant: NETZSCH-Feinmahltechnik GmbH, Selb (DE)

(72) Inventors: Hans-Georg Kißwetter, Marktredwitz (DE); Stephan Knappe, Döhlau (DE); Matthias Kapp, Weilersbach (DE)

(21) Appl. No.: 18/636,917

(22) Filed: Apr. 16, 2024

(30) Foreign Application Priority Data
Apr. 19, 2023 (DE) 10 2023 109 853.5

(51) Int. Cl. A23G 1/00; A23G 1/12

(52) U.S. Cl. CPC A23G 1/0043; A23G 1/125

(57) ABSTRACT

A device for processing a product mass, including a container for receiving the product mass, at least one product mass processing tool in the container, which is provided to act on the product mass, and at least one sensor means having a dielectric sensor, wherein the sensor means is arranged and formed in such a way that dielectric properties of the product mass can be detected continuously or at least temporarily by means of the dielectric sensor in an environment of the dielectric sensor. The invention further relates to a method for processing a product mass, in particular by means of a device of this type.

### TECHNICAL FIELD

The invention relates to a device for processing a product mass. The invention further relates to a method for processing a product mass, in particular by means of a device of this type.

Even though the invention can be used in a large variety of fields in connection with the processing of product masses, for instance during the production of the starting materials thereof and/or the completion of products of all kinds, in particular in connection with the creation and processing of pasty or dough-like or creme-like masses or other masses, which have a significant viscosity and/or which resemble a rather viscous liquid or melt, the invention and the set of problems forming the basis thereof will be described in more detail in an exemplary manner below using the example of the processing of a chocolate mass, the so-called conching, but without limiting the invention to that effect.

To make chocolates, starting materials, in particular cocoa mass, sugar, cocoa butter, milk powder and/or fat are mixed and are processed in a device provided specifically for this purpose by exerting compressive and shear forces.

During the production of high-quality chocolates, the goal is to dissolve moisture, thus water, from the chocolate mass in a conching process of this type. The chocolate mass is additionally subjected to different temperature boosts during the conching, in order to achieve that unpleasant or unwanted aromas become volatile and are discharged. It is achieved in this way that the chocolate mass has a more and more pleasant taste with increasing conching time. The process can be supported by blowing in heated-up air.

Different conching devices (also referred to as conches) can be used to conch chocolate, ranging from the original conche of Rudolf Lindt to semi-continuous high-performance conches (PIV).

The conching of chocolates is a process, which is significant for the quality of the product, but is a relatively time- and energy-consuming process. In conventional approaches, the quality of the produced, conched mass is determined at the end of the conching process, for example with regard to the reached low moisture content and/or the discharge of unwanted aromatic substances. If the result does not meet the expectations, the required quality has thus not been reached yet, the conching process is then extended.

A conching device as well as a method for conching a product mass are described, for example, in the DE 10 2017 001 784 A1.

The DE 10 2017 001 784 A1 describes detecting the weight of a product mass contained in a container, in order to determine the dehumidification degree of the product mass. For this purpose, a weighing cell is proposed, which can detect the weight of the container together with the product mass filled into said container and from this, a weight change of the product mass in the container during the conching and/or discharge operation. Based on this, the progress of the conching or discharge can be monitored.

It would be desirable to be able to even better monitor the production process during the processing of product masses, for instance those of the above-described types, for example during the conching of chocolate masses for making in particular high-quality chocolates, and to preferably be able to even better control or regulate it.

### SUMMARY

In light of the foregoing, it is an object of the invention to provide for a processing of a product mass, which can be monitored and/or controlled or regulated in an improved way and to thus provide for an even more efficient processing of a product mass.

According to the invention, this object is solved by means of a device for processing a product mass with the features of claim 1 and/or by means of a method for processing a product mass with the features of claim 14.

According to this, a device for processing a product mass is proposed, which has a container for receiving the product mass, at least one product mass processing tool in the container, which is provided for acting on the product mass, and at least one sensor means comprising a dielectric sensor.

The sensor means is thereby arranged and formed in such a way that dielectric properties of the product mass can be detected continuously or at least temporarily by means of the dielectric sensor in an environment of the dielectric sensor.

According to the invention, a method for processing a product mass, in particular by means of a device of this type, is furthermore proposed, wherein the method has the steps of:
filling the product mass and/or starting material for creating the product mass into a container;
acting on the product mass by means of at least one product mass processing tool in the container, wherein the product mass is processed or formed and processed by means of contact with the product mass processing tool, and the product mass processing tool is at least temporarily in contact with the product mass; and
detecting, by means of a sensor means comprising a dielectric sensor, dielectric properties of the product mass in an environment of the dielectric sensor, wherein the detecting takes place continuously or at least temporarily, while the product mass is located in the container.

An idea, on which the invention is based, is to carry out an inline determination of a property of the product mass, which is to be monitored and is to reach a predetermined value, for example, based on the dielectric properties as physical properties of the product mass, for example an inline determination of the moisture content or a good approximation for this moisture content. With the help of the invention, the physical nature of the product mass, which is expressed in the dielectric properties thereof, can be assumed directly thereby.

The dielectric properties of the product mass can advantageously be detected and evaluated at desired points in time or at predetermined time intervals or also continuously without significant time delay. A monitoring of the desired property, for instance of the moisture content is thus preferably possible in real time or at least close to real time, with the help of the invention. It is made possible in this way to control the processing of the product mass in real time or at least close to real time and to optimize it, for example. For example, the processing can be ended at a point in time, which is optimal with regard to one or several predetermined criteria. One/several other control variable(s) of the processing process could further be varied systematically for the optimization, based on the monitored property, for an optimal result. It can be made possible additionally to implement a regulation with a suitable regulating variable, for example the desired property of the product mass, such as, for instance, the moisture content.

The invention advantageously avoids a taking of samples or the like. The taking of samples is not only associated with work but can further place high demands on care and cleanliness especially with regard to a desired purity and freedom from contamination of the product mass—for example in the case of food, such as chocolate, but also in the case of cosmetics and the like— and can concomitantly further increase the expenditure of personnel, time and material. Effort of this type can be reduced or avoided with the use of the dielectric analysis, as proposed by the present invention.

Advantageous designs and further developments of the invention follow from the subclaims as well as from the description with reference to the drawings.

In one design, the sensor means is configured in such a way that a temperature of the product mass can further be detected continuously or at least temporarily by means of the sensor means in the environment of the dielectric sensor. In particular the dielectric properties and the temperature at least for essentially the same region of the product mass can be detected thereby. With regard to the dielectric analysis, for example, the permittivity and/or the loss factor can, in the general case, be a function of the temperature, thus, for example, for water. By detecting the dielectric properties and additional detection of the temperature at the same detection point, in other words at least for an identical spatial volume element of the product mass, a conclusion can be drawn in a meaningful manner to the nature of the product mass at the detection point, for example to the current moisture of the product mass.

For example, the sensor means can be formed with a temperature sensor, wherein the temperature sensor can be, for example, a thermocouple or a measuring resistor. The temperature sensor can be formed, for example, as a platinum resistance sensor or a copper resistance sensor.

It is in particular provided that the dielectric properties and the temperature in the environment of the dielectric sensor can essentially be detected simultaneously.

In one design, the product mass processing tool is arranged in the container so as to be capable of being moved relative thereto and is formed to mechanically act on the product mass. This provides for an expedient mechanical processing of the product mass, for example by exerting forces on it, for instance compressive forces and/or shear forces on the product mass. The container can be arranged so as to be stationary in the room, for example, and the product mass processing tool can be arranged so as to be capable of being moved relative to the container in the latter. The product mass processing tool can in particular be provided for a circulating movement around a center or an axis. In the case of other designs, however, the container can, alternatively, be arranged, for example, so as to be capable of being moved and the product mass processing tool so as to be stationary, or, in further designs, a relative movement of both can be achieved by moving the container as well as the product mass processing tool in the room.

In the case of a further development, the sensor means is arranged on a wall of the container. In this way, the sensor means can be arranged so as to be easily accessible and the connection thereof can be simplified, in particular in connection with a stationary container.

In one design, the sensor means can be arranged in a lower region of the wall of the container, in particular in a lower half of the wall, more preferably in a lower third of the wall. In this way, the force of gravity can be used to ensure a good contact of the product mass with the sensor means, which contributes to a reliable detection of the dielectric properties and optionally of the temperature.

According to a further development, the sensor means is arranged in a region of the wall of the container, which is swept over repeatedly by the product mass processing tool during operation. In the case of a further development of this type, the contact of the sensor means with the product mass and the reliability of the detection can be improved additionally, in that the product mass processing tool pushes or displaces the product mass, for example under pressure, against the sensor means.

In a further design, a surface of the sensor means, which faces an inner region of the container receiving the product mass and which is provided for a contact with the product mass, is arranged set back relative to a wall inner surface of the container. In this way, it can be ensured in an improved way that a portion of the product mass stays in good contact with the measuring surface of the sensor means for a period of time, which is sufficient for detecting the dielectric properties and optionally the temperature. A depression in the container wall can in particular be formed, on the base of which the surface of the sensor means is located. It can be provided that the product mass processing tool repeatedly sweeps over the region of the depression at a small distance and repeatedly pushes portions of the product mass into the depression, which contributes to a good contact with the sensor means, provides for an increase of the dwell time of the product mass, and allows for an always current detection by means of routine replacement of the product mass in the depression.

In one design, the device can further be provided with several sensor means, which each have a dielectric sensor for temporarily or continuously detecting dielectric properties of the product mass, in each case in an environment of the dielectric sensor. The several sensor means can further in particular each be configured for the continuous or temporary detection of a temperature of the product mass. This can contribute to a further improvement of the reliability of the detection of dielectric properties and in particular further of the temperature. For example, an averaging or a weighted averaging can be performed via the several values, which reflect the dielectric properties and optionally the temperature and which are detected by the several sensor means. This can be used, for example, to compensate or to combine effects of a relatively large movement speed of the product mass processing tool and of the dwell time of a volume element of the product mass on the sensor means limited thereby. The use of several dielectric sensors can contribute to an even higher certainty of the measured dielectric values, for example via an averaging.

In a further development, the several sensor means are arranged along a circumferential direction of the container.

The several sensor means can in particular be arranged spaced apart from one another along a path, which the product mass processing tool follows repeatedly during the processing of the product mass during operation of the device. In this way, the sensor means can be swept over one after the other by means of the product mass processing tool at a small distance, and a new portion of the product mass can thereby in particular be brought into contact with the sensor means in each case. The path can follow, for example, the circumferential direction of the container at a distance from the wall of the container.

According to another design, the sensor means can be arranged on an element, which is provided for a contact with the product mass and which is located in the container. The element can in particular be movably arranged in the container. For example, the sensor means can be arranged on the product mass processing tool. A good contact of the sensor means with the product mass is thus made possible in an alternative way because during the processing of the product mass, the product mass processing tool intensively comes into contact therewith.

In a further development, the sensor means can be arranged in the region of an effective area of the product mass processing tool, in particular within an effective section of the product mass processing tool, which pushes the product mass against the wall of the container in a processing operation of the device. This can even further improve the contact of a measuring surface of the sensor means with the product mass.

In a further design, it is conceivable to simultaneously provide the sensor means arranged on the wall and the sensor means arranged on the element in the container, in particular the product mass processing tool, wherein the device then has at least two of the sensor means in the case of a design of this type.

In one design, the device is formed for processing a food product mass. The utilization of a dielectric sensor for reaching a usable approximate value, for example for a moisture content of the product mass, makes a frequent taking of samples unnecessary, avoids associated effort and simplifies a clean and hygienically flawless mode of operation. In an analogous design, the method can be used for processing a food product mass.

In one design, the device is formed as a conching device for processing a chocolate mass, and the product mass processing tool is a conching tool. During the conching of chocolate mass, it is significant for the quality of the chocolate to lower the moisture content of the chocolate mass below a defined threshold value, whereby unwanted aromatic substances are additionally discharged. In an advantageous manner, the invention provides for an inline monitoring of the moisture content and an optimization of the process during the processing, whereby, as mentioned, physical properties of the product mass are resorted to directly. In a further development, the method can analogously be used for processing a chocolate mass.

In a further design, the device and the method can be formed for processing one of a plurality of other food product masses, for example during the production and/or finished processing of ketchup, mayonnaise or sauces, or, for example, during the production and/or finished processing of spreadable food, such as spreads, or during the production and/or finished processing of milk products, such as, for instance, yoghurt, or during the processing of honey.

In other designs, the device and the method can be used during the processing of other product masses, which are not food.

In one design, the device and the method can be formed, for example, for processing a paint material product mass or a coating material product mass, in particular during the production of paints or varnishes. In a further development, the device and the method could alternatively be used for processing a viscous sealing means or adhesive.

According to a further design, the device and the method can be formed for processing a cosmetic product mass or drug product mass, for example during the production of cremes, ointments or pastes.

A good monitoring and control of the processing process is made possible in an advantageous manner in particular in the case of the above-mentioned further application cases, as well as a clean, low-contamination process is further simplified at the same time, for example.

In one design of the method, the product mass processing tool for processing or forming and processing the product mass is moved within the container relative thereto. The product mass processing tool can thereby be moved, for example, along a path, for example along a circular path, and can thereby perform a circulating movement around a center or an axis. This provides for an expediently implementable processing of the product mass in the container.

In a further development of the method, at least one movement pause is provided, during which the moving of the product mass processing tool is interrupted or significantly slowed down. It is provided thereby that the detection of the dielectric properties during the movement pause takes place during standstill or significantly slowed-down movement of the product mass processing tool or that the detection of the dielectric properties takes place continuously and an evaluation of the dielectric properties detected is performed during the movement pause during standstill or significantly slowed-down movement of the product mass processing tool. A dwelling of a product mass volume in contact with the sensor means can be achieved in an effective way by means of a movement pause of this type, which contributes to a particularly reliable detection of the dielectric properties.

A duration of the movement pause can be, for example, at least approximately one minute. This can contribute to obtaining stable, reliable measuring results by means of the sensor means and can take into account the expected setting time, which passes until reaching a stable level of the measuring values.

According to a further development, several movement pauses are provided. In the movement pauses, the product mass processing tool is thereby in each case brought to a standstill essentially at the same position along a movement path of said product mass processing tool or is moved in a slowed-down manner. This provides for a repeated measurement at different points in time in a comparable configuration of container, tool and product mass.

The product mass processing tool is preferably brought to a standstill within a section of the movement path thereof or is moved in a slowed-down manner, in that the product mass processing tool sweeps over an attachment location of the dielectric sensor. This contributes to a good contact of product mass and sensor.

The product mass processing tool is further preferably brought to the standstill or slowed down in such a way that an effective section of the product mass processing tool, which pushes the product mass against the wall of the container in a processing operation of the device, covers the attachment location of the dielectric sensor during the standstill or the significantly slowed-down movement. This provides for a further improved contact with the product mass and a further improved detection of the dielectric properties.

In one design of the method, a temperature of the product mass is continuously or at least temporarily detected in the environment of the dielectric sensor simultaneously with the dielectric properties. The advantages of the temperature detection are already mentioned above.

In a further development, an approximation or estimation is in particular formed for a property of the product mass, which is to be monitored, in particular a moisture content of the product mass, by using the detected dielectric properties and the detected temperature. A usable statement about the property to be monitored can thus be obtained on the basis of current physical conditions in the product mass.

According to a further design, the dielectric properties, in particular the dielectric property and the temperature, of the product mass can be detected at several detection points. The detection points can thereby in particular be arranged spaced apart from one another along a path, which the product mass processing tool follows repeatedly during the processing of the product mass and can be swept over consecutively by the product mass processing tool. For example, an averaging or a weighted averaging can be carried out via the several values for the dielectric properties and optionally the temperature, which are detected at the several detection points. The advantageous effects of a further development of this type are already mentioned above.

In a further development, the approximation or estimation for the property of the product mass to be monitored can be formed by using the detected values for the dielectric properties and the temperature at the several detection points.

It goes without saying that the above designs and further developments can each be applied analogously to the device as well as the method of the present invention.

If useful, the above designs and further developments can be combined arbitrarily with one another. Further possible designs, further developments and implementations of the invention also comprise combinations, which are not mentioned explicitly, of features of the invention described above or below with respect to the exemplary embodiments. The person of skill in the art will thereby in particular also add individual aspects as improvements or additions to the respective basic form of the present invention.

### BRIEF DESCRIPTION OF THE DRAWINGS

The invention will be described in more detail below on the basis of the exemplary embodiments, which are specified in the schematic figures of the drawing, in which:

FIG. 1 shows a device formed as a conching device for processing a product mass according to a first exemplary embodiment, in a longitudinal central section;

FIG. 2 shows a detail D of the sectional illustration of FIG. 1 for the conching device according to the first exemplary embodiment;

FIG. 3 shows a partial illustration of the conching device of FIG. 1 in a cross section I-I;

FIG. 4 shows a shaft means of the conching device according to the first exemplary embodiment, comprising a shaft and conching tools arranged thereon comprising scrapers as well as deflecting tools;

FIG. 5 shows a device formed as a conching device for processing a product mass according to a second exemplary embodiment, in a longitudinal central section;

FIG. 6 shows a device formed as a conching device for processing a product mass according to a third exemplary embodiment, in a longitudinal central section;

FIG. 7 shows a detailed illustration in the environment D′, see FIG. 6, of a sensor means of the device according to the third exemplary embodiment, in a state with product mass processing tool, which sweeps over;

FIG. 8 shows a partial cross sectional illustration of a device formed as conching device for processing a product mass according to a fourth exemplary embodiment;

FIG. 9 shows a detailed illustration, analogous to FIG. 2, of a conching device according to a fifth exemplary embodiment in a longitudinal central section thereof;

FIG. 10 shows a detailed illustration, analogously to FIG. 7, of a conching device according to a sixth exemplary embodiment in a longitudinal central section thereof;

FIG. 11 shows a shaft means of a device formed as conching device for processing a product mass according to a seventh exemplary embodiment, comprising a shaft and conching tools arranged thereon comprising scrapers as well as deflecting tools;

FIG. 12 shows a partial cross sectional illustration of the conching device according to the seventh exemplary embodiment;

FIG. 13 shows a schematic flow chart for the illustration of methods according to exemplary embodiments of the invention; and

FIG. 14 shows an exemplary sensor means, which can in each case be used in the case of the exemplary embodiments of FIG. 1-13, in a side view.

The enclosed drawings are to give a broader understanding of the embodiments of the invention. They illustrate embodiments and, in connection with the description, serve the purpose of describing principles and concepts of the invention. Other embodiments and many of the mentioned advantages follow with regard to the drawings. The elements of the drawings are not necessarily shown true-to-scale to one another.

Unless stated otherwise, elements, features and components, which are identical, functionally identical and which act identically, are in each case provided with the same reference numerals in the figures of the drawing.

### DETAILED DESCRIPTION

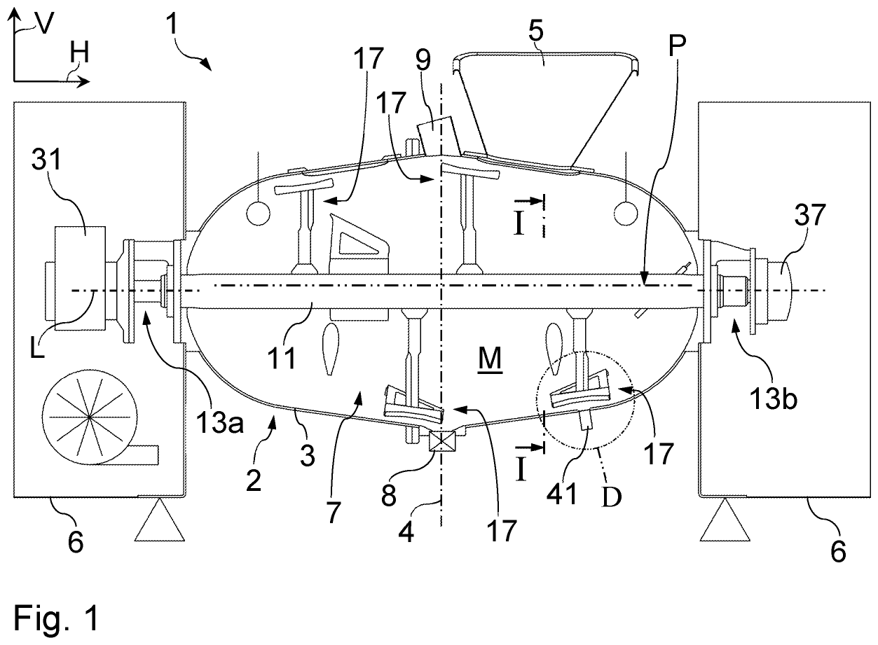

FIG. 1 shows a device 1 formed as conching device for processing a product mass M according to a first exemplary embodiment, whereby the product mass M is a chocolate mass. The device 1 has a container 2, which has a wall 3 and receives the product mass M. The product mass M to be processed and/or starting material in the form of raw materials for forming the product mass M can be filled via a filling funnel 5 in an upper region of the container 2 into the latter. An inner region of the container 2 receives the product mass M, wherein a fill level P is plotted in FIG. 1, up to which the product mass M or the starting material is filled in. The product mass and/or the starting material is/are suggested in FIG. 1 by means of the reference numeral M only by identifying the region, in which it is/are present.

The inner region of the container 2 and the wall 3 are formed essentially mirror-symmetrically to a vertical plane of symmetry 4. The container 2 extends with a longitudinal thereof essentially along a horizontal direction H and is coupled in a stationary manner on both sides with a frame assembly 6 in each case. The stationary frame assemblies 6, which are spaced apart from one another in the horizontal direction H, are each supported via supports on an essentially horizontal bottom.

The device 1 has a shaft means 7 comprising a shaft 11, wherein the shaft 11 extends through the container 2 in such a way that an axis of rotation and longitudinal axis L of the shaft 11 runs essentially parallel to the horizontal direction H. Ends 13a, 13b of the shaft 11 are in each case rotatably mounted in one of the frame assemblies 6. The shaft 11 can rotate about its longitudinal axis L within the container 2, in order to process the product mass M.

A product outflow 8 comprising an optionally openable and closable valve means, through which the product mass M can be conveyed out of the container 2 at the end of the processing, is provided on an underside of the container 2 in the region of the plane of symmetry 4. An air outlet 9 is further arranged on an upper side of the container 2, in the region of the plane of symmetry 4.

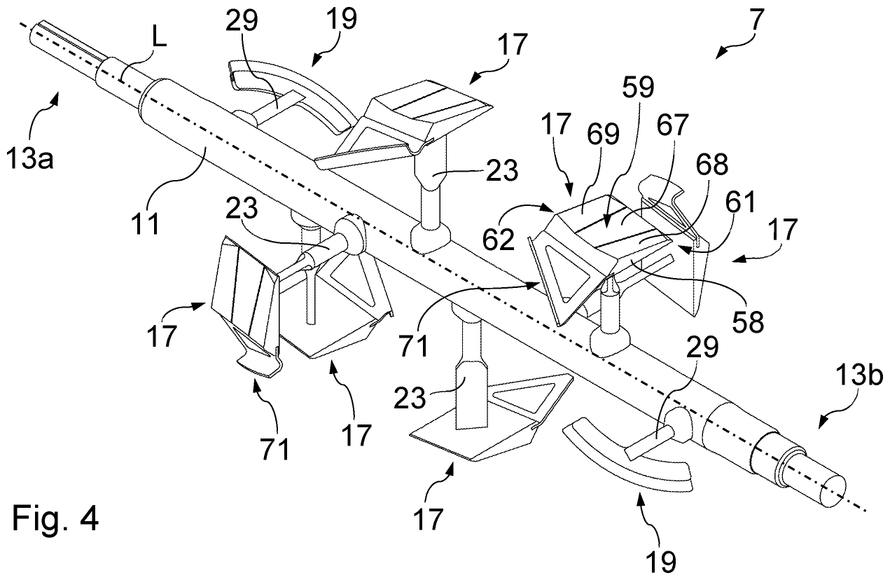

On a section of the shaft 11 received within the container 2, said shaft has several product mass processing tools 17, which are formed as conching tools and which are arranged at regular intervals on the shaft 11. Product mass deflecting tools 19 are further arranged on the shaft 11 on the section of the shaft 11 received in the container 2, in each case adjacent to the ends 13a and 13b, in such a way that the product mass processing tools 17 are located between the product mass deflecting tools 19 in the axial direction along the axis L. FIG. 4 shows the shaft means 7 comprising the shaft 11 and comprising the several tools 17 and 19 in a perspective manner.

The product mass processing tools 17 are in each case arranged through a positioning section 23 at a respective predetermined radial distance from the shaft 11 and are firmly connected to the shaft 11. The product mass processing tools 17 in each case further have a body 58 comprising an effective surface 59 as well as comprising a scraper 71 coupled to the body 58. Except for their positioning along the longitudinal axis L and in the circumferential direction of the shaft 11 as well as the alignment of the scraper 71 and the effective surface 59, the product mass processing tools 17 are formed largely identical to one another.

The product mass deflecting tools 19 are in each case likewise firmly connected to the shaft 11 by means of a positioning section 29 in the respective predetermined manner, spaced apart from said shaft and are formed for creating a desired product mass flow within the container 2.

In response to a rotation of the shaft 11 about the longitudinal axis L thereof, the tools 17, 19 thus each move on a circular path B circulating around the axis L. The shaft means 7 thereby rotates with the tools 17, 19, which are firmly connected to the shaft 11, as a uniform body. For processing purposes, the product mass M can be acted on mechanically with the help of the product mass processing tools 17, which are formed as conching tools, in that said product mass is subjected to compressive and/or shear forces between the effective surface 59 and the wall 3. The inner region of the container 2 is formed essentially rotationally symmetrically around the axis L, so that the product mass processing tools 17 in each case move along the circular path B, wherein the body 58 moves at an essentially constant distance from the inner side of the wall 3 relative to the latter. The circular path B thus follows a circumferential direction U of the wall 3 at an essentially constant distance therefrom.

On its first end 13a, see FIGS. 1 and 4, the shaft 11 is coupled to a drive assembly 31. The drive assembly 31 is provided in the frame assembly 6, which is arranged on the left side in FIG. 1 and is formed to drive the shaft 11 for the rotation about the axis L thereof. On its second end 13b, the shaft 11 is further rotatably mounted about the longitudinal axis L in a bearing unit 37. The bearing unit 37 is provided in the frame assembly 6, which is arranged on the right side in FIG. 1.

The effective surface 59 of each of the product mass processing tools 17 has an inlet-side region 61 in a product mass processing operation of the device 1 and an outlet-side region 62, wherein the region 61 is located upstream of the region 62, viewed in a circumferential of the tool 17, which corresponds to the rotation R. An intermediate space between the effective surface 59 and the inner side of the wall 3 narrows from the first region 61 towards the second region 62 and widens downstream from the second region 62. An effective section of the product mass processing tool 17 between the region 61 and the region 62 can thus push the product mass M against the wall 3 during the processing of said product mass.

The effective surface 59 comprises a central depression 67, which extends in the direction of the circular path B and the width of which decreases opposite to the circumferential direction of the tool 17. On both sides of the depression 67, the effective surface 59 further each has an edge region 68, 69, wherein the edge regions 68, 69 are in each case inclined relative to the surface of the depression 67.

In cooperation with a wall inner surface 47 of the wall 3, the above-described geometry of the effective surface 59 illustrated graphically in FIG. 1-4 makes it possible to mechanically act on the product mass M during the rotation R and to process it. With respect to the longitudinal axis L, the effective surface 59 of the product mass processing tool 17 is arranged radially on the outer side of the latter and thus faces the wall inner surface 47. During the rotation R of the shaft 11, a portion of the product mass M, which reaches between the effective surface 59 and the wall inner surface 47, is subjected to compressive and/or shear forces, and the chocolate mass M is thus processed, which is referred to as conching of the chocolate mass M. During the rotational movement R, the scraper 71 follows the body 58 and moves relative to the wall inner surface 47 at a small distance from the latter or abuts against the wall inner surface 47 during the movement.

The conching device 1 of FIG. 1 further has a sensor means 41. The sensor means 41 includes a dielectric sensor 44, by means of which dielectric properties of the product mass M can be detected continuously or at least temporarily in an environment of the dielectric sensor 44. The detected values thereby generally specify physical properties of the product mass M in a partial volume of the product mass M, which is in contact with the sensor means 41. In particular the permittivity, the dielectric loss factor and/or variables derived therefrom, such as, for example, the ion conductivity and/or the ion viscosity, can be considered as detected physical, dielectric properties.

The sensor means 41 is configured in such a way that a temperature of the product mass M can additionally be detected continuously or at least temporarily in the environment of the dielectric sensor 44 by means of the sensor means 41. The dielectric properties and the temperature can in particular be detected at the same point in time and with regard to an essentially identical volume element of the product mass M in particular by means of the sensor means 41. In other words, the dielectric properties and the temperature can be detected essentially at the same point of the product mass M.

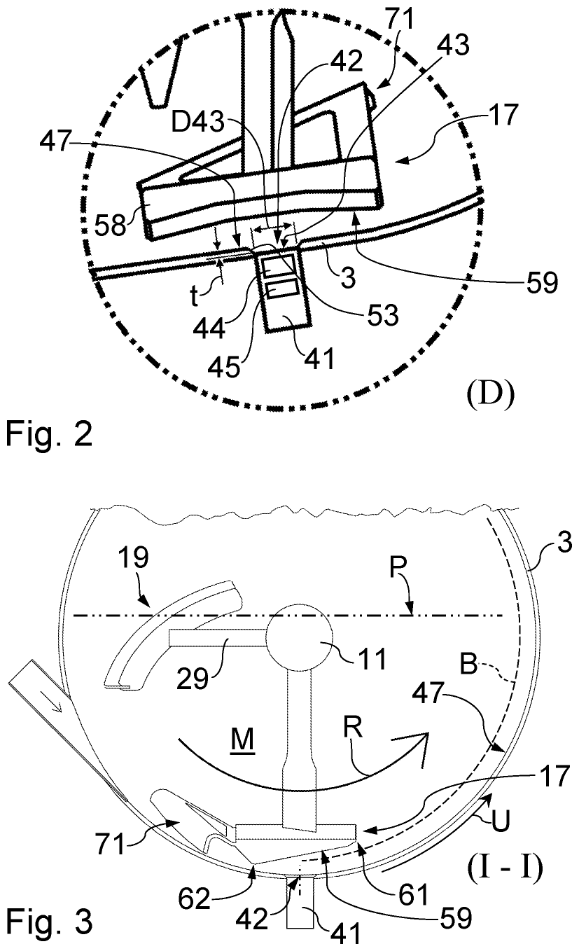

In the case of the first exemplary embodiment, the sensor means 41 is arranged on a wall 3 of the container 2, is thus stationary in the room and can thus be connected and supplied in a simple and easily accessible way. A detection point 42 for the dielectric properties and the temperature is defined in this way. The arrangement in the region of the wall 3 is illustrated in more detail in the detail D in FIG. 2. The sensor means 41 is formed as a sensor unit, the essentially circular surface 43 of which, which is effective for the measurements of the dielectric property/properties and the temperature, faces the product mass M in the inner region of the container 2. Other geometric shapes of the surface 43 are likewise conceivable, but a round design contributes to a simple and expedient accommodation of the sensor means 41 in the wall 3. In FIG. 2, a diameter of the surface 43 is identified with D43. For instance in an example of a relatively small conching device with a nominal capacity of, for example, 300 kg, D43 can, for example, be between approximately 4 cm and approximately 5 cm. However, larger or smaller dimensions are likewise conceivable and D43 can be between approximately 1 cm and approximately 6 cm, for instance for conching devices of other capacities. In the case of a different example, D43 for smaller conching devices can be between approximately 2 cm and approximately 3 cm.

During operation of the device 1, the surface 43 comes into contact with the product mass M. With respect to the wall inner surface 47 of the container 2, the surface 43 is set back by a distance t, whereby a depression 53, which, in the case of the shown exemplary embodiment, is likewise round, is formed in the wall 3. The surface 43 is arranged on the bottom of the depression 53. The depth t of the depression 53 can be, for example, between approximately t=1 mm and approximately t=10 mm.

The sensor means 41 is arranged on the wall 3 in such a way that it is swept over repeatedly by the product mass processing tool 17, which moves on the circular path B for processing the product mass M in the interior of the container 2. A radial distance is provided between the wall 3 and the body 58 of the product mass processing tool 17. A layer height of the product mass M above the detection point 42 can be, for example, between approximately 5 mm and approximately 15 mm.

By means of the movement of the product mass processing tool 17, another portion of the product mass M is repeatedly pushed into the depression 53. To simplify this and to thus promote the exchange of the product mass M located in the depression 53, the depression 53 is beveled on the edge thereof, which faces the interior of the container 2, or is provided with a chamfer. Alternatively, the edge of the depression 53 facing the interior of the container 2 can be equipped with a rounding.

In the case of the exemplary embodiment of FIGS. 1 to 4, the sensor means 41 includes, for example, a dielectric sensor 44 in monotrode construction for the dielectric analysis (DEA). The dielectric sensor 44 thereby operates according to the principle of a plate capacitor, wherein the environment, including the analyzed product mass M, acts as second electrode. The capacity of this measuring capacitor, in addition to the geometric dimensions thereof and the dielectric constant in the vacuum, is also a function of the dielectric constant in the environment of the electrode of the sensor 44, which is embodied as monotrode. In the case of changes to the dielectric properties of the environment, which are located at a typical distance from the active measuring surface 43 of the dielectric sensor 44, the electrical resistance or the electrical conductivity, respectively, also changes.

In the case of the exemplary embodiments described in the present case, the generated resistance and thus the dielectric behavior changes during the process of the processing of the product mass M. An alternating voltage applied with a predetermined frequency and a predetermined amplitude as well as a resulting alternating current and a phase shift between input voltage and output current is measured via a measuring and control electronics of a dielectric analyzer (DEA) via the dielectric sensor 44—which, as described above, is formed in an exemplary manner with a monotrode as simple electrode, wherein the entire environment, including the product mass M, acts as second electrode. The signal detected by means of the sensor 44 is recorded, for example, and can be evaluated for the process by means of a software. Significant dielectric measuring variables, which change in the course of the process, for example permittivity or dielectric loss factor, are thereby displayed and evaluated with the help of the software. Variables derived from these measuring variables, such as, for example, the ion viscosity, serve as relevant values for the description of the process. In the case of the exemplary embodiment described for instance in the present case with reference to FIGS. 1 to 4, as well as in the case of the further below exemplary embodiments, the measuring frequency, thus the frequency of the applied alternating voltage can be, for example, 1 kHz. Measurements at other frequencies are conceivable.

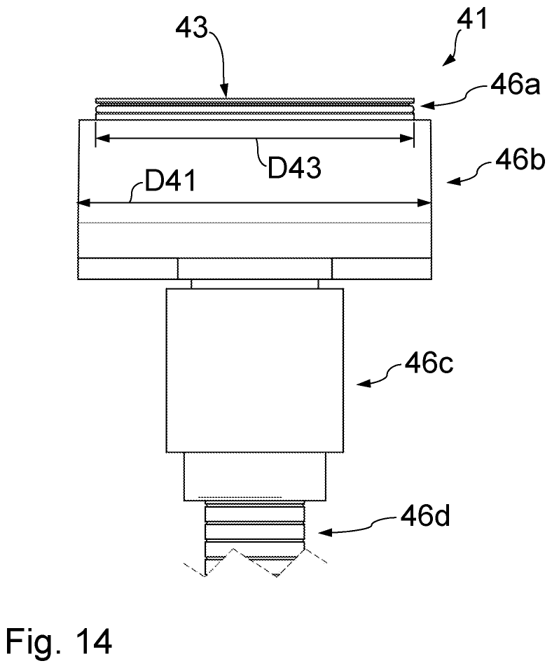

FIG. 14 shows an exemplary sensor means 41 in side view, wherein the surface 43 facing the product mass M for the measurement and the diameter D43 thereof are also shown. The sensor means 41 is formed as a unit comprising a first essentially cylindrical section 46a, a second essentially cylindrical section 46b and a third essentially cylindrical section 46c. The sections 46a, 46b, 46c are arranged coaxially to one another. The first section 46a has the diameter D43 and supports the surface 43. The second section 46b, which has a diameter D41, which is larger than D43 and forms an outer diameter D41 of the sensor means 41, follows the section 46a. For example, D41 can be approximately 5 cm. The sections 46a, 46b thus connect to one another with a circumferential step. The third section 46c, the diameter of which is smaller than D43, connects to the section 46b on the side thereof facing away from the section 46a. A connecting line 46d for the sensor means 41 leads away from the section 46c to the outside.

To detect the temperature of the product mass M, the sensor means 41 can additionally comprise a measuring resistor, for instance a platinum or copper measuring resistor, or can instead have a thermocouple. The measuring resistor, for instance Pt or Cu measuring resistor, or the thermocouple thereby forms a temperature sensor 45, which, together with the dielectric sensor 44, is installed in a sensor means 41 as sensor unit, see also FIG. 2. Measuring value pairs or sets with dielectric property/properties and temperature can always be detected in this way for the detection point 42. A detection of the dielectric property/properties at the detection point 42 can thus also be made possible, for example, as function of the temperature.

All of the above-mentioned sensors or measuring elements do not represent an exhaustive list. It is clear for the person of skill in the art that instead of the sensor means 41, all of the sensors and/or measuring means known to the person of skill in the art as such, which are suitable for detecting the measuring variables relevant for the production of the product mass M, can be installed.

The dielectric sensor 44 and the temperature sensor 45 are illustrated in FIG. 2 in a purely schematic manner as components of the sensor means 41, which provide for the detection of dielectric properties and temperature at the point 42. In particular the relative arrangement of both sensors 44, 45 to one another can thereby deviate from the arrangement shown schematically in FIG. 2.

To process the product mass M, here for conching the chocolate mass, the device 1 is operated in the below-described manner, which is illustrated schematically in FIG. 13 in the manner of a flow chart.

Shown in FIG. 13 is a schematic sequence with a step S1 of a filling in of product mass M and/or starting material, several processing steps S2a, S2b, S2c to S2n, as well as several movement pauses S3a, S3b, S3c to S3n, and a step S4 of the removal or discharging of the product mass M.

In step S1, the product mass M and/or starting material for creating the product mass M is/are filled into the container 2. For example, raw materials comprising cocoa mass, sugar, cocoa butter and milk powder can be filled into the container 2 up to the fill level P in step S1. The product mass M and/or the raw materials is/are not illustrated graphically in the figures but only suggested by marking the region, in which the mass M and/or the raw materials is or are present, respectively.

In step S2a, the shaft 11 is set into rotation R by means of the drive assembly 31 and the raw materials located in the container 2 as well as the product mass M, which forms therefrom, is processed by means of the drive assembly 31, i.e., conched in the present case. A mechanical processing and a mixing of the product mass M, an application of forces to the product mass M by means of the effective surfaces 59 as well as a discharge of moisture and unwanted aromatic substances via the air outlet 9 takes place thereby. The rotation of the shaft 11 in step S2a is continued for a period of time, which is predefined, for example, and the mass is continuously processed in the meantime. The moisture content F of the mass M is to be reduced thereby to a desired low target moisture content FSOLL, FINAL until the end of the entire processing process, thus prior to the discharging in step S4.

Starting at the start of the processing in step S2a, for example, dielectric properties of the product mass M as well as the temperature are in each case continuously detected in the environment of the dielectric sensor in a time-resolved manner and preferably simultaneously by means of the sensor means 41. The detection of the dielectric properties and of the temperature in this way is continued in the case of an exemplary embodiment, until the processing of the product mass M is ended and the product mass M is discharged from the container 2 in step S4.

With increasing drying of the product mass M and decline of the moisture content F, changes in the dielectric properties occur, which can be detected by means of the sensor means 41. The behavior of ions and dipoles in the electrical alternating field are detected with the help of the dielectric analysis. Ions move to the oppositely charged electrode. This ion mobility is also referred to as ion conductivity. With continued drying of the product mass M, the ion conductivity declines, for example, while the so-called ion viscosity increases accordingly. The detected temperature of the product mass M is also considered, and the determined moisture contents of the product mass M can thus always be compared at identical temperatures and can be correlated well.

At the end of the processing time period for the step S2a, the shaft 11 is stopped in a predefined position and the movement of the product mass processing tools 17 is thus interrupted. The shaft 11 is thereby brought to a standstill in such a way that one of the product mass processing tools 17, which routinely passes the attachment location of the sensor means 41 and thus the detection point 42 thereof, comes to a stop in a section of its circular path B, in which it currently sweeps over the sensor means 41. The product mass processing tool 17 is preferably brought to a standstill in a position, in which the sensor means 41 is located between the regions 61 and 62 and a portion of the product mass M is pushed against the sensor means 41. FIG. 3 shows a position of this type of one of the product mass processing tools 17 in an exemplary manner.

In step S3a, the shaft 11 dwells for a period of time t3a, which, in turn, can be predefined, for example. The time-resolved detection of the dielectric properties and of the temperature is continued in the meantime. The values for the dielectric properties and the temperature detected during the period of time t3a of the standstill or during a section thereof, for example of a subinterval within the period of time t3a of the standstill, are evaluated, in other words, an approximate value for the property of the product mass M to be monitored, the moisture content F in the present case, is formed from these values. This approximate value can then be compared, for example, to the final target value FSOLL, FINAL or a time-dependent target value FSOLL (t) or both.

In view of the fact that the processing brings about a continued recirculation and mixing of the product mass M, the local detection of the dielectric property and of the temperature advantageously makes it possible to make a statement above the respective current moisture content of the entire product mass M in the container with good accuracy. In this way, the processing process, here the conching, can be monitored in a significantly improved way and can in particular be controlled or regulated as a function of the measuring result, thus of the obtained approximate value for the moisture content F. The processing of the product mass M can be designed more efficiently in this way, a short as well as an excessive processing can be reliably avoided.

Following step S3a, the shaft 11 is set into rotation R again in step S2b and the product mass M is further processed, as described above. Step S2b is followed by further movement pause S3b with renewed evaluation of the values detected by the sensor means 41, as described for S3a. This is followed by a further processing step S2c and a further movement pause S3c, as just described. The number of processing steps and movement pauses can be adapted, as needed. For example, n processing steps and n movement pauses can generally be provided. The standstill of the product mass processing tool 17 preferably always takes place at the same position of the product mass processing tool 17 along the path B thereof, in other words in the same angular position of the shaft 11.

With regard to the length of time, for example a length of the processing steps t2a, t2b, t2c, . . . , t2n of approximately 0.5 h each and a length t3a, t3b, t3c, . . . , t3n of the movement pauses of approximately 1 min each, can be provided during the conching process of chocolate mass M, which often takes several hours. Other durations are conceivable, however. In the case of some variations, it can additionally further be provided that for example the length of the processing steps is not constant, but varies over the entire processing time, the time distribution of the evaluation of detected values over time is thus not uniform.

In a variation of the method illustrated in FIG. 13, it can furthermore be provided that the detection of values for the dielectric properties and/or the temperature by means of the sensor means 41 is performed only in the movement pauses S3a-S3n or in each case a time interval thereof and thus at standstill of the shaft 11, and the values detected in this way are evaluated for the movement pauses S3a-S3n or in each case for a partial interval thereof.

In a variation of the approach described above with reference to FIG. 13, it is conceivable to provide a rotation R of the shaft 11, which is highly slowed down relative to the processing operation in the steps S2a-S2n, in the movement pauses S3a-S3n instead of complete standstill. In the case of this variation, the above furthermore applies analogously.

During the processing process, heated-up air can be introduced through a supply duct into the interior of the container 2, for example in one, several or all of the steps S2a-S2n. The supply of additions, for instance fat-containing additions, is also possible.

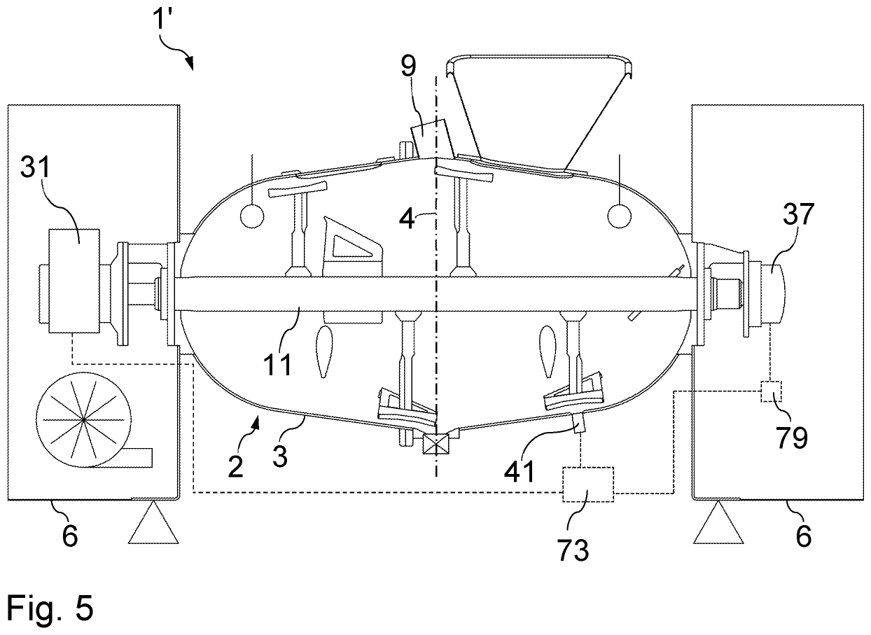

For a device 1′ according to a second exemplary embodiment, an evaluation and control device 73 is illustrated schematically in FIG. 5, by means of which drive assembly 31 is controlled and the detected values for the dielectric properties and the temperature, which the sensor means 41 provides, are evaluated. Based on the result of the evaluation, the operation of the device 1′ is controlled by means of the evaluation and control device 73. In order to always be able to stop the shaft 11 in the same angular position or to be able to slow it down in the variation, for a reliable measurement in the movement pauses S3a-S3n, as described above, an angle of rotation detecting means 79 is additionally provided, the detected value of the angle of rotation is also processed by the control device 73, in order to control the drive assembly 31 to implement the movement pauses S3a-S3n. The embodiments for the first exemplary embodiment furthermore also apply to the device 1′. The device 73 can in particular further be designed as evaluation and regulating device 73, in order to implement a regulation with a regulating variable, such as, for instance, the moisture content F.

It can be seen from FIG. 1-3 that the sensor means 41 in the case of the first exemplary embodiment is arranged in a lower region of the wall 3, and thereby at the lowest point of the cross section of the container 2, for example at the location of the product mass processing tool 17, which is arranged farthest on the right in FIG. 1. Looking at the entire container 2, the sensor means 41 is located in a lower third of the wall 3, based on the vertical direction V.

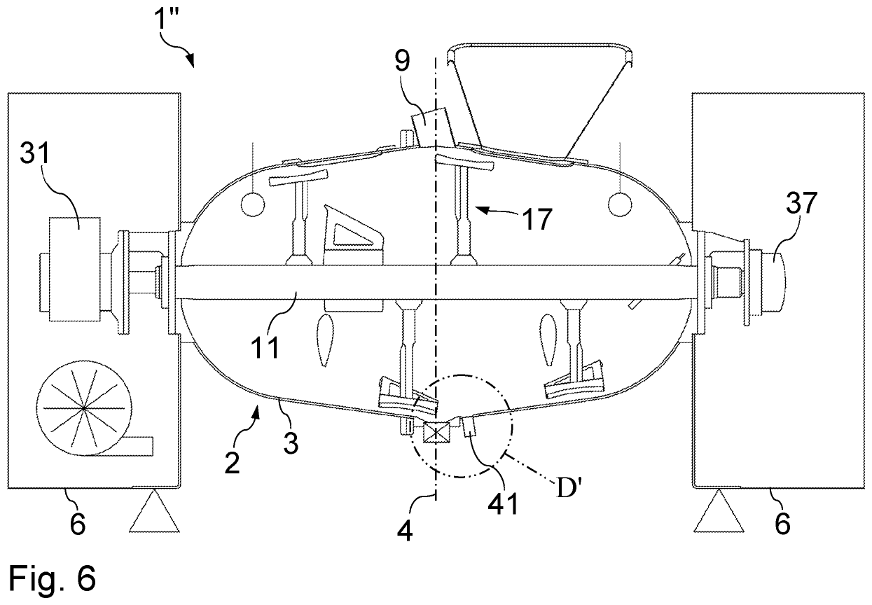

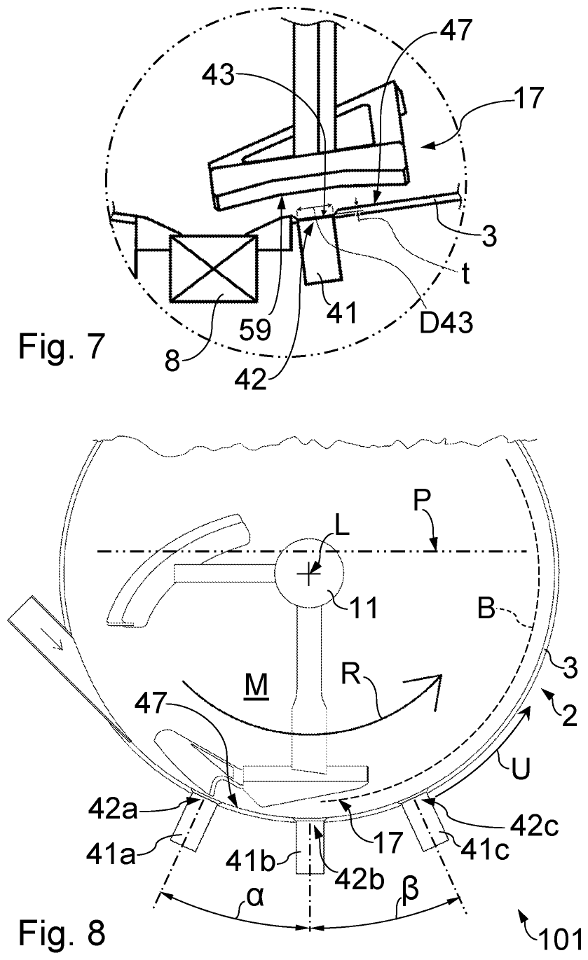

The sensor means 41 can alternatively be arranged, for example, on a point close to the plane of symmetry 4, which is located even farther towards the lowest point of the container 2 in the longitudinal central section thereof. This is outlined in FIG. 6 for a third exemplary embodiment of the invention. As in the case of the above-described exemplary embodiments, one of the product mass treatment tools 17 also sweeps over the sensor means 41 in FIG. 6. Except for the location of the arrangement of the sensor means 41, the conching device 1″ of FIG. 6 is formed analogously to the device 1 or 1′ according to the first or second exemplary embodiment of FIG. 1-5. FIG. 7 shows the arrangement of the sensor means 41 according to FIG. 6 in detail at the point identified with D′ in FIG. 6, together with the return offset of the surface 43 of the sensor means 41 by the distance t.

A device 101 according to a fourth exemplary embodiment is illustrated in FIG. 8 and differs from that of the first exemplary embodiment in that the device 101 is provided with several sensor means 41a, 41b and 41c. Three sensor means 41a-c are provided in FIG. 8, whereby two or more than three sensor means are likewise conceivable, however. Each of the sensor means 41a-c is formed in the same way as the sensor means 41 described above with reference to the first exemplary embodiment and is operated as such, as described above. Beyond the above, the device 101 of FIG. 8 is constructed in the same way as the device of FIG. 1-4 or 5.

FIG. 8 shows a partial cross sectional illustration through the device 101 in the region of the container 2, analogously to the section I-I suggested in FIG. 1.

As in the case of the above-described exemplary embodiments, the product mass processing tool 17 moves on a circular path B around the axis L, when the shaft 11 is set into rotation R by means of the drive assembly 31, wherein the circular path B follows a circumferential direction U of the container 2 at a constant distance from the wall inner surface 47. The several sensor means 41a, 41b, 41c are arranged in the wall 3 in the circumferential direction U along the path B, in other words, on a projection thereof onto the wall inner surface 47, in each case spaced apart from one another. In FIG. 8, the distance of the sensor means 41a, 41b is specified as an angle α and the distance of the sensor means 41b, 41c as an angle β, wherein, for example, a curve length along the wall inner surface 47 could instead be specified, however. In the case of the exemplary embodiment of FIG. 8, the sensor means 41a-c are spaced apart evenly from one another, so that α=β thus applies.

In order to obtain a good approximation for the current moisture content F of the product mass M, here, for example, of the chocolate mass, in an inline process, an averaging or weighted averaging of the values detected by the sensor means 41a, 41b, 41c at the detection points 42a, 42b or 42c, respectively, along the path B in the region of the surfaces 43 can in each case further be performed for the dielectric properties and the temperature in the case of the fourth exemplary embodiment. It is conceivable thereby to shorten the standstill times in the above-described movement pauses S3a-S3n or in the variation, the times of slowed-down movement, respectively, or to omit the movement pauses and to achieve a sufficiently exact approximation with the help of the averaging over several measuring points 42a, 42b, 42c.

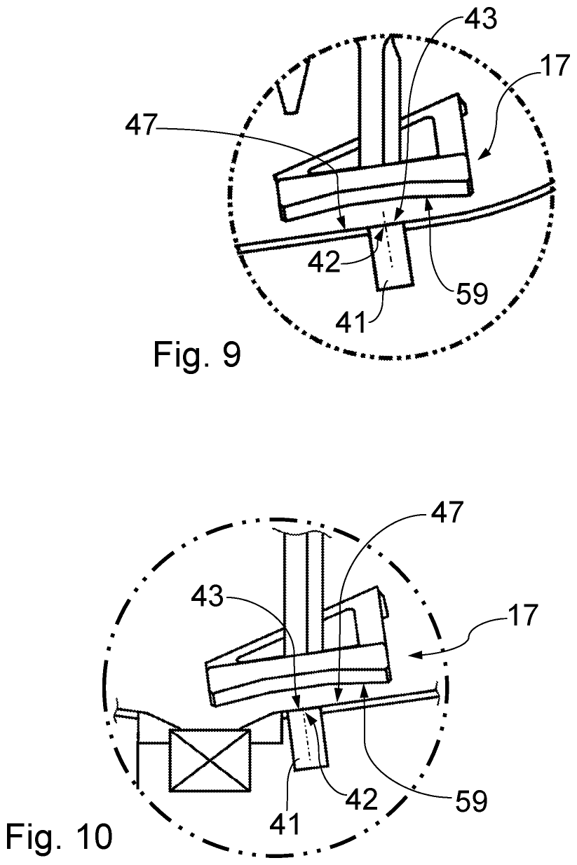

A detail of a device according to a fifth exemplary embodiment is illustrated in FIG. 9. The device of the fifth exemplary embodiment differs from the device 1, 1′ according to the first or second exemplary embodiment of FIG. 1-4 or 5, respectively, only in that the sensor means 41 is arranged in the wall 3 of the container 2 in such a way that the surface 43, which comes into contact with the product mass M, is flush with the wall inner surface 47. The flushness can further simplify, for example, the cleaning of the device, whereby a sufficient dwell time of the mass M in contact with the surface 43 is ensured, for instance by means of movement pauses, as described above.

FIG. 10 analogously shows a device according to a sixth exemplary embodiment, which differs from the device 1″ of FIGS. 6 and 7 only in that the surface 43 of the sensor means 41 is, in turn, flush with the wall inner surface 47.

It goes without saying that a flush arrangement of the surface 43 with the inner surface 47, as in FIG. 9 or 10, can likewise be provided when the device has several sensor means 41a-c, for instance along the path B. In a variation of the fourth exemplary embodiment of FIG. 8, the surface 43 of one, several or all of the sensor means 41a-c can in particular be flush with the wall inner surface 47, wherein the processing of the values detected at the several detection points in the case of a design of this type can additionally contribute to reducing or correcting effects of shortened dwell times of the product mass M in contact with the surfaces 43.

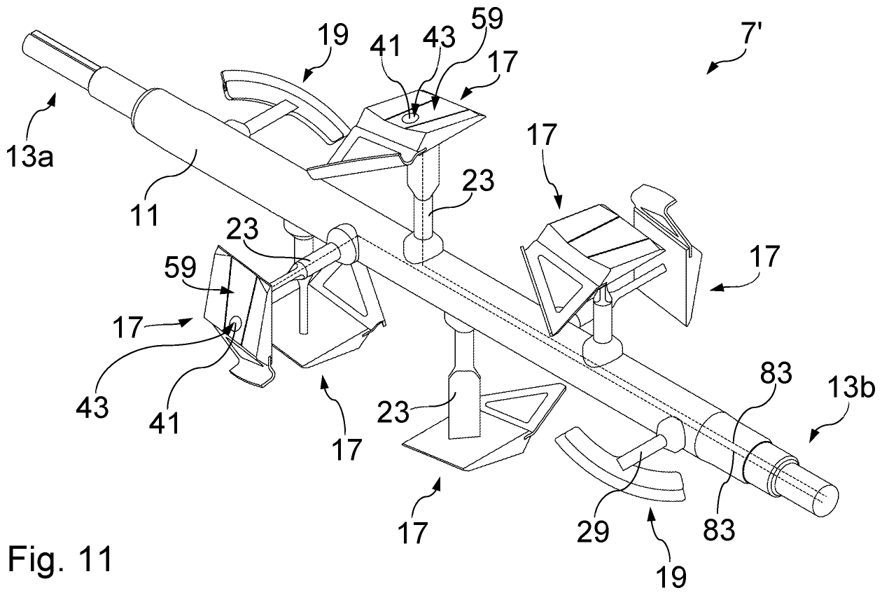

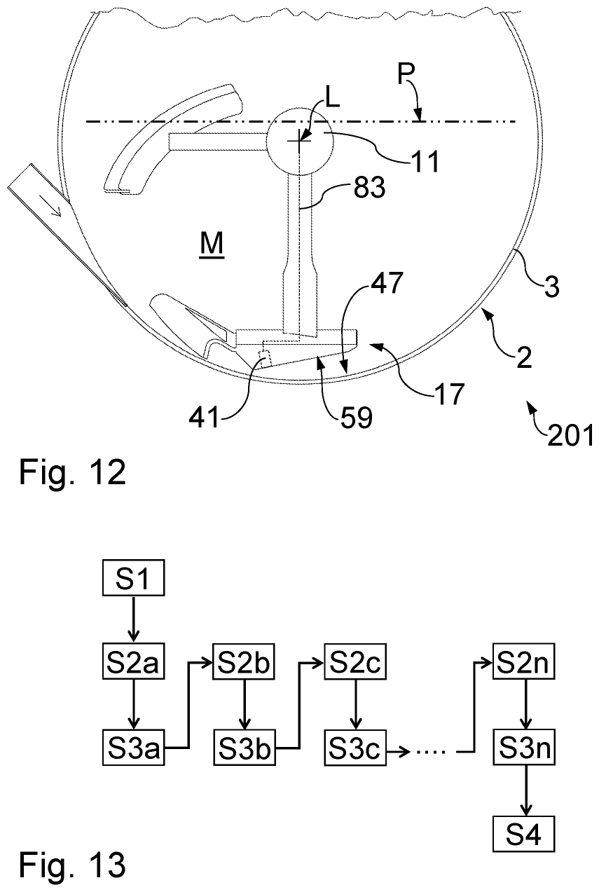

A device 201 for processing a product mass M according to a seventh exemplary embodiment will be described below with reference to FIGS. 11 and 12. For this purpose, the differences of the seventh exemplary embodiment compared to the first exemplary embodiment will be described below, whereby, beyond this, reference is made to the above.

In the case of the seventh exemplary embodiment, the device 201 has a modified shaft means 7′. In its mechanical setup, the shaft means 7′ corresponds to the shaft means 7, whereby one or several of the product mass processing tools 17, in FIG. 11 for example two of them, is additionally equipped or are equipped in each case, respectively, with a sensor means 41, however. In contrast to the first exemplary embodiment, the sensor means 41 in the case of the seventh exemplary embodiment is thus not arranged in the region of the wall 3, but the sensor means 41 is or are, respectively, arranged on the product mass processing tool 17, which is provided for the contact with the product mass M, which exerts compressive and/or shear forces onto portions of the product mass M. In the case of the example of FIG. 11, 12, the surface 43 of the sensor means 41, which is effective for the measurement, is in each case arranged in the region of the effective surface 59 in the effective section between the regions 61 and 62.

In the case of the seventh exemplary embodiment for the sensor means 41, the detection of the dielectric properties and of the temperature and the evaluation thereof or the evaluation thereof during continuous detection in each case takes place for a position of the product mass processing tool 17, which supports the sensor means 41 and in which a good contact of the product mass M with the sensor means 41 is at hand, for example in the position of the tool 17 shown in FIG. 12. In the case of the seventh exemplary embodiment, as described above with regard to FIG. 13, movement pauses S3a, S3b, S3c, . . . , S3n can also be provided in order to improve the detection.

The sensor means 41 in FIG. 11 in each case correspond to the sensor means 41 described above for the fourth exemplary embodiment, in particular with regard to setup and mode of operation.

The control of the sensor means 41 and the detection of values for the dielectric properties and the temperature can be reached, for example, with the help of lines 83, which are guided through the positioning section 23 and the shaft 11 and which are contacted to the outside on the shaft end 13b. Alternatively, a wireless transmission would be conceivable.

In particular in the case of the seventh exemplary embodiment, a detection of the angular position of the shaft can take place by means of the angle of rotation detecting means 79, in order to detect and evaluate values for the dielectric properties and the temperature for periods of time or time intervals, in which the surface 43 is in contact with the mass M. Alternatively or additionally to the angle of rotation detection, a mechanical resistance, which has to be overcome by the drive assembly 31 for the rotation R, can additionally be detected in a time-resolved manner for this purpose, in order to determine those periods of time, in which a product mass processing tool 17 with sensor means 41 dips into the product mass M.

In a variation of the seventh exemplary embodiment, the sensor means 41 could be arranged on one of the product mass deflecting tools 19.

In a further variation, it is further conceivable to use the shaft means 7′ of the seventh exemplary embodiment or the variation thereof in the case of one of the devices according to the first to sixth exemplary embodiment or the variations thereof.

According to the above exemplary embodiments, what is thus described are in particular methods for the inline determination of the moisture content during the conching process in the chocolate production, as well as devices, by means of which methods of this type can be carried out.

The present invention, however, is not limited to the processing or the conching of a chocolate mass, but can be used for the processing of a large variety of product masses M. The invention can be used, for example, for processing other food masses, of product masses from the field of cosmetics or drugs, or of product masses from the field of paints or coating agents or sealing agents or adhesives, wherein, for example, the shape of the container 2 and/or of the processing tools 17 and optionally deflecting tools 19 can be adapted to the respective mass M. In the case of other masses of this type, a different property of the product mass to be monitored, for which conclusions can be drawn based on the dielectric properties and, for example, the temperature, and an approximation can be calculated, can additionally be selected instead of the moisture content.

Even though the present invention has been described completely on the basis of preferred exemplary embodiments, it is not limited thereto, but can be modified in many different ways.

For example, the invention is not limited to the geometric design of the container and the product mass processing tools as well as the number of the latter, as described above and shown in the figures.

1. A device for processing a product mass, comprising a container for receiving the product mass,
at least one product mass processing tool in the container, which is provided to act on the product mass, and
at least one sensor means having a dielectric sensor, wherein the sensor means is arranged and formed in such a way that dielectric properties of the product mass can be detected continuously or at least temporarily by means of the dielectric sensor in an environment of the dielectric sensor.

2. The device according to claim 1,
characterized in that the sensor means is configured in such a way that a temperature of the product mass can further be detected continuously or at least temporarily by means of the sensor means in the environment of the dielectric sensor, and in particular that the dielectric properties and the temperature at least for essentially the same region of the product mass can be detected.

3. The device according to claim 1,
characterized in that the product mass processing tool is arranged in the container so as to be capable of being moved relative thereto and is formed to mechanically act on the product mass.

4. The device according to claim 1,
characterized in that the sensor means is arranged on a wall of the container.

5. The device according to claim 4,
characterized in that the sensor means is arranged in a lower region of the wall of the container, in particular in a lower half of the wall, more preferably in a lower third of the wall.

6. The device according to claim 4,
characterized in that the sensor means is arranged in a region of the wall of the container, which is swept over repeatedly by the product mass processing tool during operation of the device.

7. The device according to claim 1,
characterized in that a surface of the sensor means, which faces an inner region of the container receiving the product mass and which is provided for a contact with the product mass, is arranged set back relative to a wall inner surface of the container.

8. The device according to claim 1,
characterized in that the device is provided with several sensor means, which each have a dielectric sensor for temporarily or continuously detecting dielectric properties of the product mass, in each case in an environment of the dielectric sensor and which are in particular each further configured for the continuous or temporary detection of a temperature of the product mass.

9. The device according to claim 8,
characterized in that the several sensor means are arranged along a circumferential direction of the container.

10. The device according to claim 8,
characterized in that the several sensor means are arranged spaced apart from one another along a path, which the product mass processing tool follows repeatedly during the processing of the product mass during operation of the device.

11. The device according to claim 1,
characterized in that the sensor means is arranged on an element, which is provided for a contact with the product mass and which is located in the container, for example on the product mass processing tool.

12. The device according to claim 1,
characterized in that the device is formed for processing a food product mass.

13. The device according to claim 1,
characterized in that the device is formed as a conching device for processing a chocolate mass and the product mass processing tool is a conching tool.

14. A method for processing a product mass in a container, with at least one product mass processing tool in the container, which is provided to act on the product mass, and at least one sensor means having a dielectric sensor, wherein the sensor means is arranged and formed in such a way that dielectric properties of the product mass can be detected continuously or at least temporarily by means of the dielectric sensor in an environment of the dielectric sensor, the method including the steps of:
filling the product mass and/or starting material for creating the product mass into a container;
acting on the product mass by means of at least one product mass processing tool in the container, wherein the product mass is processed or formed and processed by means of contact with the product mass processing tool, and the product mass processing tool is at least temporarily in contact with the product mass; and
detecting, by means of a sensor means having a dielectric sensor, dielectric properties of the product mass in an environment of the dielectric sensor, wherein the detecting takes place continuously or at least temporarily, while the product mass is located in the container.

15. The method according to claim 14,
characterized in that the product mass processing tool for processing or forming and processing the product mass is moved within the container relative thereto.

16. The method according to claim 15,
characterized in that at least one movement pause is provided, during which the moving of the product mass processing tool is interrupted or significantly slowed down and that the detection of the dielectric properties during the movement pause takes place during standstill or slowed-down movement of the product mass processing tool or the detection of the dielectric properties takes place continuously and an evaluation of the dielectric properties detected during the movement pause during standstill or slowed-down movement of the product mass processing tool is performed.

17. The method according to claim 15,
characterized in that several movement pauses are provided and in the movement pauses, the product mass processing tool is in each case brought to a standstill essentially at the same position along a movement path of said product mass processing tool or is moved in a slowed-down manner, whereby the product mass processing tool is preferably brought to a standstill or is moved in a slowed-down manner within a section of the movement path thereof, in that the product mass processing tool sweeps over an attachment location of the dielectric sensor.

18. The method according to claim 14,
characterized in that simultaneously with the dielectric properties, a temperature of the product mass is detected continuously or at least temporarily in the environment of the dielectric sensor.

19. The method according to claim 14,
characterized in that the dielectric properties, in particular the dielectric properties and the temperature, of the product mass are detected at several detection points and in particular that the detection points are thereby arranged spaced apart from one another along a path, which the product mass processing tool follows repeatedly during the processing of the product mass and are swept over consecutively by the product mass processing tool.
